(19) United States
(12) Patent Application Publication
(10) Pub. No.: US 2015/0062906 A1
(43) Pub. Date: Mar. 5, 2015

(54) PORTABLE FRAMING PROJECTOR

(71) Applicant: Mountain Springs Holdings, LLC, Murray, UT (US)

(72) Inventor: Glenn Merlin Johnson, Murray, UT (US)

(21) Appl. No.: 14/473,349

(22) Filed: Aug. 29, 2014

Related U.S. Application Data
(60) Provisional application No. 61/872,488, filed on Aug. 30, 2013.

(51) Int. Cl. F21V 13/02; F21V 11/00; F21V 23/00; F21V 21/00; F21V 5/04

(52) U.S. Cl. CPC F21V 13/02; F21V 21/00; F21V 5/04; F21V 23/001; F21V 11/00
USPC 362/280; 362/311.01

(57) ABSTRACT

An apparatus includes a framing projector with a light source and one or more focusing elements that focus light from the light source on a desired area of an object. The one or more focusing elements are to prevent light from the light source from lighting areas outside the desired area. The apparatus includes a projector housing. The framing projector is mounted inside the projector housing. The apparatus includes an electrical cord terminating at a plug configured to plug into an electrical outlet. The electrical cord provides power to the framing projector. The apparatus includes a stand coupled to the projector housing and/or the framing projector. The stand maintains the projector housing and framing projector in an upright position above a substantially horizontal surface when the stand is positioned on the substantially horizontal surface. The stand supports the projector housing and framing projector against gravity loading of the apparatus.

### CROSS-REFERENCES TO RELATED APPLICATIONS

This application claims the benefit of U.S. Provisional Patent Application No. 61/872,488 entitled “PORTABLE FRAMING PROJECTOR” and filed on Aug. 30, 2013 for Glenn Merlin Johnson, which is incorporated herein by reference.

### FIELD

This invention relates to framing projectors and more particularly relates to a portable framing projector.

### BACKGROUND

A framing projector is a light fixture typically used to illuminate a target, which is often art, an architectural element, a specific location, etc. Typical framing projectors are mounted in a ceiling or to a track in a fixed position and include one or more lenses to direct light in a specific direct so that the light is in the form of a beam of light. Framing projectors typically include a slot with a custom template. The custom template is shaped to shade areas around the target so that light from the framing projector falls on the target and not on areas beyond the target. This form of directing light at a target while excluding areas around the target provides a dramatic contrast to highlight the target with light.

Typical framing projectors are rigidly mounted so that a custom template can be created based on distance between the framing projector and target, based on the angle of light from the framing projector, etc. Precise mounting of the framing projector is desired to avoid additional adjustments or creation of more than one custom template.

### SUMMARY

An apparatus for lighting includes a framing projector with a light source and one or more focusing elements that focus light from the light source on a desired area of an object. The one or more focusing elements are to prevent light from the light source from lighting areas outside the desired area. The apparatus includes a projector housing. The framing projector is mounted inside the projector housing. The apparatus includes an electrical cord terminating at a plug, where the plug is configured to plug into an electrical outlet. The electrical cord provides power to the framing projector. The apparatus includes a stand coupled to the projector housing and/or the framing projector. The stand maintains the projector housing and framing projector in an upright position above a substantially horizontal surface when the stand is positioned on the substantially horizontal surface. The stand supports the projector housing and framing projector against gravity loading of the apparatus.

In one embodiment, the stand is free from attachment to the substantially horizontal surface. In another embodiment, the stand includes a tri-pod. The tri-pod includes a base attached to the projector housing and three legs attached to the base. In a further embodiment, the tri-pod further includes an adjustable extension coupled to the base of the tri-pod and to the projector housing, where the adjustable extension adjusts to vary a height of the projector housing from the substantially horizontal surface. In another embodiment, the one or more focusing elements include a telescopic lens.

In one embodiment, the framing projector includes one or more adjustable shutters movably coupled to the framing projector, where the shutters are adjustable to shape light from the framing projector and/or an iris assembly connected to the framing projector, where the iris assembly includes an adjustable iris. In another embodiment, the framing projector includes a slot. The slot is shaped to accommodate a custom template. The custom template is shaped for the object illuminated by the framing projector. In a further embodiment, the slot includes a slot for an adjustable shutter and the custom template replaces the adjustable shutter.

In one embodiment, the apparatus includes a power converter. The power converter is mounted external to the projector housing and is coupled to the stand. The power converter receives power from the electrical cord and provides power to the framing projector. The power converter converts electrical power from the electrical cord to a different form prior to providing power to the framing projector. In one example, the power converter includes a ballast for the light source, an LED driver, a switching power supply and/or a transformer. In another example, the power converter includes a portion of the stand and the power converter includes a base housing surrounding the power converter. The base housing includes a lower portion in contact with the substantially horizontal surface, and the apparatus includes a support that extends from the base housing to the projector housing and is arranged to support the projector housing. The base housing and the support make up the stand and the base housing maintains the projector housing in the upright position above the substantially horizontal surface.

In one embodiment, the projector housing includes an exterior in the shape of a spot light shape, a telescope shape, or a theatrical spotlight shape. In another embodiment, the stand is shaped as a bird cage surrounding the projector housing where a window in the bird cage allows light from the framing projector to illuminate or an observatory shape wherein the projector housing is shaped as a telescope extending from the observatory.

Another apparatus for lighting includes a framing projector with a light source and one or more focusing elements that focus light from the light source on a desired area of an object. The one or more focusing elements prevent light from the light source from lighting areas outside the desired area. The apparatus includes one or more adjustable shutters movably coupled to the framing projector, where the shutters are adjustable to shape light from the framing projector, an iris assembly connected to the framing projector, where the iris assembly includes an adjustable iris, and/or a slot shaped to accommodate a custom template, where the custom template is shaped for the object illuminated by the framing projector. The apparatus includes a projector housing, where the framing projector is mounted inside the projector housing, and an electrical cord terminating at a plug. The plug is configured to plug into an electrical outlet, and the electrical cord provides power to the framing projector.

The apparatus includes a stand coupled to the projector housing. The stand maintains the projector housing and framing projector in an upright position above a substantially horizontal surface when the stand is positioned on the substantially horizontal surface, and the stand supports the projector housing and framing projector against gravity loading of the apparatus. The stand includes a tri-pod, where the tri-pod has a base attached to the projector housing and three legs attached to the base.

In one embodiment, the tri-pod includes an adjustable extension coupled to the base of the tri-pod and to the projector housing, where the adjustable extension adjusts to vary a height of the projector housing from the substantially horizontal surface. In another embodiment, the apparatus includes a power converter. The power converter is mounted external to the projector housing and is coupled to the stand. The power converter receives power from the electrical cord and provides power to the framing projector. The power converter converts electrical power from the electrical cord to a different form prior to providing power to the framing projector. In another embodiment, the power converter includes a portion of the stand. The power converter also includes a base housing surrounding the power converter, where the base housing includes a lower portion in contact with the substantially horizontal surface. The apparatus includes a support that extends from the base housing to the projector housing and which is arranged to support the projector housing. The base housing and the support make up the stand. The base housing maintains the projector housing in the upright position above the substantially horizontal surface. In one embodiment, the projector housing includes an exterior in the shape of a spot light shape, a telescope shape, or a theatrical spotlight shape.

Another apparatus for lighting includes a framing projector with a light source and one or more focusing elements that focus light from the light source on a desired area of an object. The one or more focusing elements prevent light from the light source from lighting areas outside the desired area. The apparatus includes one or more adjustable shutters movably coupled to the framing projector, where the shutters are adjustable to shape light from the framing projector, an iris assembly connected to the framing projector, where the iris assembly includes an adjustable iris, and/or a slot shaped to accommodate a custom template, where the custom template is shaped for the object illuminated by the framing projector. The apparatus includes a projector housing, where the framing projector is mounted inside the projector housing. The projector housing includes an exterior in the shape of a spot light shape, a telescope shape, or a theatrical spotlight shape. The apparatus includes an electrical cord terminating at a plug. The plug is configured to plug into an electrical outlet, and the electrical cord is for providing power to the framing projector.

The apparatus includes a stand coupled to the projector housing. The stand maintains the projector housing and framing projector in an upright position above a substantially horizontal surface when the stand is positioned on the substantially horizontal surface. The stand supports the projector housing and framing projector against gravity loading of the apparatus. The stand includes a tri-pod, where the tri-pod includes a base attached to the projector housing and three legs attached to the base. The tri-pod includes an adjustable extension coupled to the base of the tri-pod and to the projector housing, where the adjustable extension adjusts to vary a height of the projector housing from the substantially horizontal surface. The apparatus includes a power converter. The power converter is mounted external to the projector housing and is coupled to the stand. The power converter receives power from the electrical cord and provides power to the framing projector. The power converter converts electrical power from the electrical cord to a different form prior to providing power to the framing projector.

In one embodiment, the power converter includes a portion of the stand. The power converter also includes a base housing surrounding the power converter, and the base housing includes a lower portion in contact with the substantially horizontal surface. The apparatus includes a support that extends from the base housing to the projector housing and which is arranged to support the projector housing. The base housing and the support form the stand. The base housing maintains the projector housing in the upright position above the substantially horizontal surface.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a side view illustrating one embodiment of an apparatus with a portable framing projector in accordance with an embodiment of the present invention;

FIG. 1B is an exploded view illustrating a portion of the embodiment of the apparatus with the portable framing projector in accordance with an embodiment of the present invention;

FIG. 2 is a side view illustrating another embodiment of an apparatus with a portable framing projector in accordance with the present invention;

FIG. 3 is a side view illustrating another embodiment of an apparatus with a portable framing projector in a bird cage in accordance with the present invention; and

FIG. 4 is a side view illustrating another embodiment of an apparatus with a portable framing projector in an observatory in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

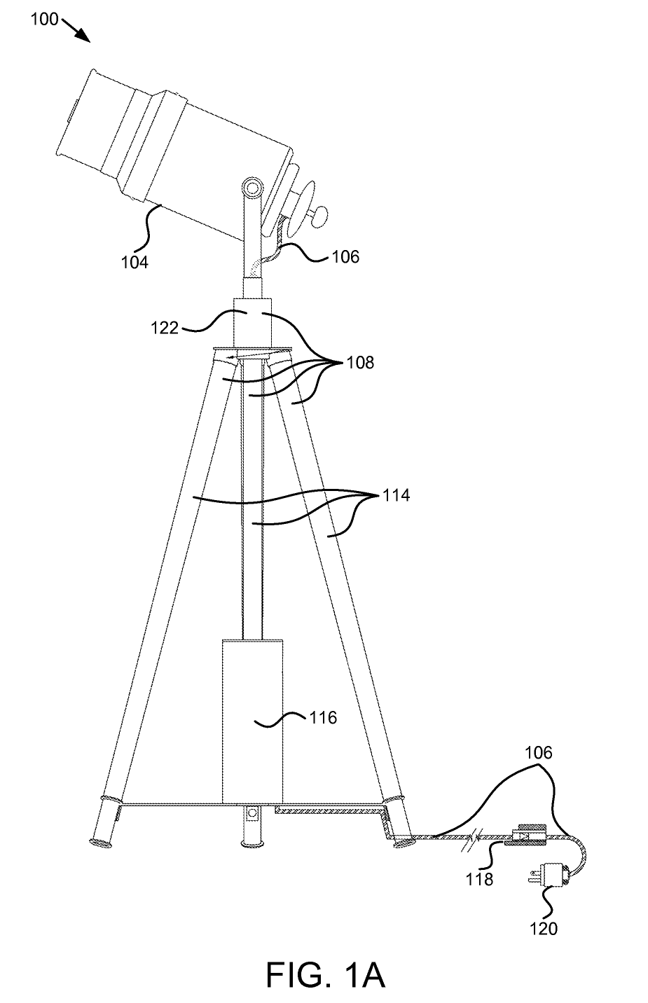

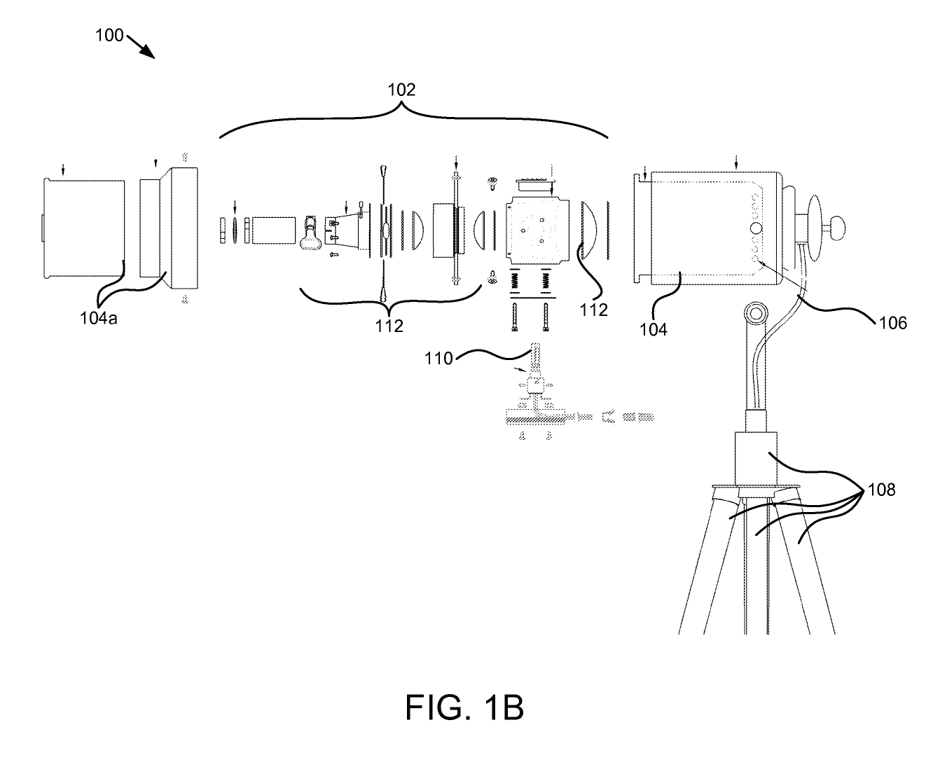

FIG. 1A is a side view illustrating one embodiment of an apparatus 100 with a portable framing projector 102 in accordance with an embodiment of the present invention. FIG. 1B is an exploded view illustrating a portion of the embodiment of the apparatus 100 with the portable framing projector 102 in accordance with an embodiment of the present invention. The apparatus 100 includes, in one embodiment, the framing projector 102, a projector housing 104, an electrical cord 106, and a stand 108, a light source 110, focusing elements 112, legs 114, a power converter 116, a floor switch 118, a plug 120, which are described below.

The apparatus 100, in one embodiment, includes a projector housing 104 with the framing projector 102 mounted inside the projector housing 104. The framing projector 102 includes a light source 110 and one or more focusing elements 112 that focus light from the light source 110 on a desired area of an object. The focusing elements 112 help to prevent light from the light source 110 from lighting areas outside the desired area. A framing projector is often used in art galleries and other locations where paintings, sculptures, etc. are displayed. A framing projector illuminates an object, such as a painting, by illuminating a desired area of the object and not illuminating outside the desired area. For example, the desired area of a painting may be the painting while the frame or matting may be outside the desired area so the framing projector illuminates the painting without illuminating the frame or matting. Framing projectors are often designed to precisely illuminate a desired area with a distinct boundary between the desired area and the non-illuminated area outside the desired area. Framing projectors typically illuminate specific shapes, such as a square, a rectangle, or a custom shape, for instance for a sculpture. Typical framing projectors are mounted on a track or ceiling or within a recess and are fixed.

In one embodiment, the projector housing 104 encloses a framing projector 102 where the framing projector 102 may have a separate housing. For example, the framing projector 102 may be manufactured separately from the projector housing 104 and elements of the framing projector 102, such as a light source 110, focusing elements 112, etc. are mounted within the housing of the faming projector. The framing projector 102 may then be mounted inside the projector housing 104. For example, the projector housing 104 may have connectors, fittings, bolts, nuts, etc. to connect to the framing projector 102. In the embodiment, the projector housing 104 includes an opening coincident with an opening in the framing projector 102 where light is emitted.

In one embodiment, the projector housing 104 includes openings to allow adjustment and operation of the framing projector 102. In another embodiment, the projector housing 104 has removable parts to gain access to the framing projector 102. For example, the projector housing 104 may be of a clamshell design with a hinge where the projector housing 104 may open to expose the framing projector 102. In another embodiment, the projector housing 104 has ports, doors, etc. that are hinged, can be slid open, etc. to expose controls and elements of the framing projector 102.

In another embodiment, the projector housing 104 includes openings where parts of the framing projector protrude. For example, an iris handle of the framing projector 102 may protrude through the projector housing 104. In the embodiment, the projector housing 104 may include slots or other openings to allow movement of the elements protruding from the framing projector 102 through the projector housing 104. In another embodiment, the projector housing 104 includes knobs, arms, levers, etc. that extend to controls of the framing projector 102. For example, a lever on the projector housing 104 may extend to an on/off switch of the framing projector 102 so that the switch is operated as the lever is moved. One of skill in the art will recognize other ways to integrate a framing projector 102 with its own housing into the projector housing 104.

In another embodiment, the projector housing 104 is integral with the framing projector 102 and parts of the framing projector 102, such as the one or more focusing elements 112 and/or the light source 110 are attached to the projector housing 104. For example, the projector housing 104 may be manufactured or fitted with elements to hold the interior components of the framing projector 102.

In another embodiment, the projector housing 104 is shaped to resemble a particular type of light fixture. For example, the projector housing 104 may resemble part of a flood light, a search light, a spot light, a track head, or other decorative light fixture known in the art. The projector housing 104 includes a place where the framing projector 102 emits light to shine on the desired area of the object. In one embodiment, the projector housing 104 includes a cover for covering the opening when the framing projector is turned off. The cover may be attached with a hinge or other mechanism to secure the cover to the projector housing 104 or may be separate. In another embodiment, the projector housing 104 includes a connection to the stand 108. In another embodiment, the projector housing 104 includes an opening for an electrical connection. The opening, in one embodiment allows an electrical cord or other covered conductors to enter the projector housing 104. In another embodiment, electrical power enters the projector housing 104 through a connection to the stand 108, for example through a hinge or rigid connection.

The apparatus 100, in one embodiment, includes an electrical cord 106 terminating at a plug 120. The plug 120 is configured to plug into an electrical outlet and the electrical cord 106 provides power to the framing projector 102. The plug 120 may be configured based on local electrical requirements. For example, the plug may be configured based on the National Electrical Manufacturers Association (“NEMA”) standards and may be a NEMA 5-15 plug to fit in residential outlets, may be a NEMA 5-20 for 20 Ampere (“A”) outlets, a NEMA L5-15 or L5-20 locking plug, a NEMA 6-15 or 6-20 plug for 240 volt (“V”) operation, etc. Other countries have different standards. The electrical cord 106 and plug 120 may be configured to any applicable standard to provide appropriate power to the framing projector 102.

In another embodiment (not shown) the framing projector 102 is battery powered. In another embodiment, the framing projector 102 receives power wirelessly. In one embodiment, the apparatus 100 includes a switch to turn power on and off to the framing projector 102. The switch, in the depicted embodiment, is a floor switch 118 that allows a user to step on the floor switch 118 to turn power on and off to the framing projector 102. In another embodiment, the switch is in the projector housing 104. In another embodiment, the switch is internal to the projector housing 104 or other component of the apparatus 100 and is controlled wirelessly. In another embodiment, the switch is included with the power converter 116. In one embodiment, the apparatus 100 includes a data connection and the switch is controlled via the data connection. In another embodiment, the switch is a multi-position switch to control various modes of lighting in the framing projector 102. One of skill in the art will recognize other ways to configure a switch for the framing projector 102 to provide power to the framing projector 102.

In one embodiment, the apparatus 100 includes a stand 108 coupled to the projector housing 104 and/or the framing projector 102. The stand 108 maintains the projector housing 104 and framing projector 102 in an upright position above a substantially horizontal surface when the stand 108 is positioned on the substantially horizontal surface. The stand 108 supports the projector housing 104 and framing projector 102 against gravity loading of the apparatus 100 on the substantially horizontal surface, and may also support the projector housing 104 and framing projector 102 against other forces, such as wind, being bumped, etc. The substantially horizontal surface may include a floor, a top of a piece of furniture, a table, a step, a platform, a sidewalk, pavement, or other substantially horizontal surface appropriate for placing the apparatus 100 to light an object with the framing projector 102.

The stand 108 and electrical cord 106 with a plug 120 allow the apparatus 100 to be portable. The portable apparatus 100 is configured to be free-standing and configured to hold the projector housing 104 and framing projector 102 in an upright position when placed on the substantially horizontal surface. The portable nature of the apparatus 100 allows the apparatus 100 to be moved with detaching the framing projector 102 from the substantially horizontal surface. The stand 108 is positioned under the projector housing 104, in one embodiment, to be between the projector housing 104 and the substantially horizontal surface where the apparatus 100 is located. The apparatus 100 is configured so a user can pick up the apparatus 100 and to unplug the plug 120 and move the apparatus 100 to a different location.

Typically the stand 108 is designed to keep the projector housing 104 and framing projector 102 stable when resting on the substantially horizontal surface. For example, the stand 108 may include a portion that contacts the substantially horizontal surface that extends horizontally so that the apparatus 100 is less vulnerable to being tipped over. In the embodiment depicted, the stand 108 is in a tri-pod configuration with three legs 114 that flare out from a connection to a base 122 of the stand 108. In other configurations, the stand 108 may include more than three legs 114. In one embodiment, the stand 108 includes an adjustable extension coupled to the base 122 of the tri-pod and to the projector housing 104. The adjustable extension adjusts to vary a height of the projector housing 104 from the substantially horizontal surface. In another embodiment, the legs 114 are telescoping, have attachments, or otherwise are extendable to vary a height of the projector housing 104 from the substantially horizontal surface. In another embodiment, the stand 108 includes both legs 114 that extend as well as an adjustable extension coupled to the base 122 and to the projector housing 104.

In one embodiment, the stand 108 is connected to the projector housing 104 and/or framing projector 102 so that the projector housing 104 and/or framing projector 102 may be rotated vertically and/or horizontally. For example, the stand 108 may include a gimbal mounting or hinge so that the projector housing 104 and/or framing projector 102 may be adjusted so the beam of light from the light source 110 is adjusted vertically. In another embodiment, the stand 108 includes an adjustment so the projector housing 104 and/or framing projector 102 may be rotated in a horizontal plane about a vertical axis. In another embodiment, adjustment of rotating the projector housing 104 and/or framing projector 102 horizontally about a vertical axis is accomplished by rotating the entire apparatus 100, including the stand 108. In various embodiments, the stand 108, framing projector 102, and/or projector housing 104 include tightening mechanisms, such as friction mechanisms, nuts, bolts, braces, etc. to hold the projector housing 104 and/or framing projector 102 in place with respect to the stand 108 after adjustment. In one embodiment, the framing projector 102 is adjustable with respect to the projector housing 104. One of skill in the art will recognize other adjustment mechanisms.

In another embodiment, the stand 108 includes a vertical element, which may or may not be extendable, attached to a base that extends horizontally (not shown). For example, the base may be a round disk, may be legs that extend horizontally, or the like. In other embodiments, the legs may extend at various angles from the vertical element. In another embodiment, the substantially horizontal surface where the apparatus 100 is placed is not horizontal, but is on an angle or has irregularities, such as steps. In the embodiment, the apparatus 100 may include a stand 108 that adjusts for non-horizontal surfaces. For example, if the apparatus 100 is placed outside on a sloping sidewalk, the stand 108 may be adjustable to accommodate the slope. For example, if the stand 108 is a tri-pod, as depicted in FIG. 1A, the legs 114 maybe telescoping and may be adjusted to accommodate for slope. As used herein, a “substantially horizontal surface” includes surfaces that are horizontal as well as sloped surfaces where a portable apparatus 100 may be placed such that the stand 108 holds the apparatus 100 upright without other supports. For example, a substantially horizontal surface may include a slope of up to around 45 degrees. One of skill in the art will recognize other configurations of the stand 108 that will support the projector housing 104 and framing projector 102 above the substantially horizontal surface.

In various embodiments, the stand 108 and projector housing 104 are shaped to resemble various objects. For example, the stand 108 may be in the shape of a bird cage and the projector housing 104 may be inside the bird cage. In the embodiment the bird cage may support the projector housing 104 from above, below, from a side, etc. of the projector housing 104. In one variation, the bird cage may include a window and the framing projector 102 may be pointed through the window. In another embodiment, the projector housing 104 may be in the shape of a telescope and the stand 108 may be in the shape of a telescope base. In another embodiment, the projector housing 104 may be in the shape of a theatrical spotlight and the stand 108 may be in the shape of a base for a theatrical spotlight. In another embodiment, the stand 108 may be in the shape of an observatory and the projector housing 104 may be in the shape of a telescope that extends through an opening in the observatory. One of skill in the art will recognize other designs for the stand 108 and projector housing 104 that will support a framing projector 102 above a substantially horizontal surface.

The framing projector 102 includes a light source 110. The light source 110, in one embodiment, is a point source or substantially a point source. In one embodiment, the light source 110 is an incandescent lamp. In another embodiment, the light source 110 is a ceramic metal halide lamp. In another embodiment, the light source 110 is a halogen lamp. For example, the halogen lamp may be in the form of a bulb or may be in an MR16 configuration. In another embodiment, the light source 110 is a light-emitting diode (“LED”) lamp. One of skill in the art will recognize other types of lamps that may be used as a light source 110 for the framing projector 102.

The framing projector 102 also includes one or more focusing elements 112. In one example, the focusing elements 112 include a reflector placed behind the light source 110. Typically the reflector is parabolic and redirects light from the light source 110 in the direction of the object that is illuminated. The focusing elements 112 may also include one or more lenses, filters, etc. The lenses and filters may be used to focus light from the light source 110 or to filter unwanted wavelengths. For example, a filter may filter out ultraviolet light or may change a color of light from the light source 110.

In one embodiment, the focusing elements 112 include adjustable paddles or shutters or a custom template. A custom template is often used in framing projectors and is shaped based on a particular object to be illuminated and based on a particular location of the framing projector and on light emission characteristics of the framing projector. In one embodiment, the framing projector 102 includes a slot for a custom template and a custom template may be created for the framing projector 102 where the framing projector 102 is placed in a specific location and a specific distance from a specific object. Where the framing projector 102 has its own housing and is mounted in the projector housing 104, the projector housing 104 may include openings or other mechanisms to allow access to the focusing elements 112.

In another embodiment, the focusing elements 112 include adjustable shutters and/or an adjustable iris. The adjustable shutters may include four shutters where a shutter is placed above, below, and on each side of a beam of light traveling through the framing projector 102. Adjustable shutters are advantageous in a portable apparatus 100 with a framing projector 102 to allow adjustment of the shutters once the apparatus 100 is first set or is moved. For example, the portable apparatus 100 may be used at an art show where permanent or fixed placement of a traditional framing projector is impractical. The portable apparatus 100 may be set up on a temporary basis to shine light on a painting, for example, that is mounted temporarily at the art show. The adjustable shutters may be adjusted once the painting is hung and a suitable location is found for the apparatus 100 and the apparatus 100 is placed. If the apparatus 100 or painting are bumped or moved, the adjustable shutters may be easily re-adjusted. An adjustable iris on the framing projector 102 may also be adjusted.

Handles and/or other adjustment mechanisms for the adjustable shutters and iris, in one embodiment, extend through the projector housing 104. In another embodiment, at least a portion of the projector housing 104 may be removed to access the handles and/or adjustment mechanisms. For example, a front half 104a of the projector housing 104, as depicted in FIG. 1B, may be removed to access the handles and/or adjustment mechanisms. In the embodiment, the stand 108, connection to the projector housing 104, etc. may be designed to remain steady as the front half 104a is removed and replaced. For example, the stand 108 may be designed with non-slip pads between the stand 108 and the substantially horizontal surface, the stand 107 may be heavy enough or may have a low center of gravity to help prevent movement, etc. One of skill in the art will recognize ways that the apparatus 100 may be designed to remain stable during adjustments.

In another embodiment, at least some of the handles/adjustment mechanisms may be reached without removing a portion of the projector housing 104 and other handles/adjustment mechanisms are accessible when at least a portion of the projector housing 104 is removed. In another embodiment, the framing projector 102 includes a slot for a custom template and accommodates an adjustable shutter and the custom template replaces the adjustable shutter.

In one embodiment, framing projector 102 includes adjustable shutters and/or an adjustable iris which are substantially similar to those described in U.S. Provisional Patent Application No. 61/705,519 to Glenn M. Johnson, filed Sep. 25, 2012, which is included herein by reference in its entirety for all purposes.

In one embodiment, the apparatus 100 includes a power converter 116. In one embodiment, the power converter 116 is a ballast for the light source 110. A ballast is an electrical device that transforms input power, such as utility power, to a different form that may be used to start the light source 110. For example, where the light source 110 is ceramic metal halide, the power converter 116 may be ceramic metal halide ballast. The ballast may change the input voltage to a different voltage, may change frequency, etc. The ballast may also include a starting mechanism that provides a specific electrical pulse to the light source 110 to get the light source 110 to an illuminating state.

In another embodiment, the power converter 116 includes an LED driver that illuminates an LED. In another embodiment, the power converter 116 includes a transformer. In another embodiment, the power converter 116 includes an alternating current (“AC”) to direct current (“DC”) converter and may include a switching power supply. For example, the power converter 116 may transform the input voltage from 120 V AC to 12 V DC or other DC voltage. In another embodiment, the power converter 116 includes multiple stages. For example, the power converter 116 may include a stage to convert from what is available in one country (i.e. 120 V AC, 60 hertz (“Hz”) to what is available in another country 220 V AC, 50 Hz and a stage that is a ballast.

The electrical cord 106 may be in one form on an input side of the power converter 116 and in another form between the power converter 116 and the framing projector 102. For example, the electrical cord 106 between the power converter 116 and the framing projector 102 may have a different number of conductors, different insulation level, may have a different wire gauge, etc. from the electrical cord 106 feeding the power converter 116. In one embodiment, the power converter 116 is external to the projector housing 104. In another embodiment, at least a portion of the power converter 116 is internal to the projector housing 104.

In one embodiment, the power converter 116 is external to the projector housing 104, as depicted in the apparatus 100 of FIG. 1A. For example, the power converter 116 may include a housing and may be mounted below the projector housing 104 as shown. The projector housing 104 may be placed to contribute to a lower center of gravity for the apparatus 100. In one embodiment, the power converter 116 is suspended from the substantially horizontal surface as depicted in FIG. 1A. In another embodiment, the power converter 116 is mounted to the stand 108 to contact the substantially horizontal surface. In another embodiment, the power converter 116 is connected to a tube, rod, etc. that extends through the stand 108 to adjust the height of the projector housing 104. In another embodiment, a cord 106 runs from the power converter 116 to the stand 108, the projector housing 104 and/or framing projector 102.

In one embodiment, the apparatus 100 does not include a power converter 116, and a weighted element is integral with the stand 108 and is positioned to provide stability to the apparatus 100. For example, the weighted element may be placed close to the substantially horizontal surface. In another example, the weighted element includes a housing or other decorative element that adds to the appearance of the apparatus 100. One of skill in the art will recognize other ways that the power converter 116 and/or weighted element may be integrated with the apparatus 100 to add stability and to add to the intended look of the apparatus 100.

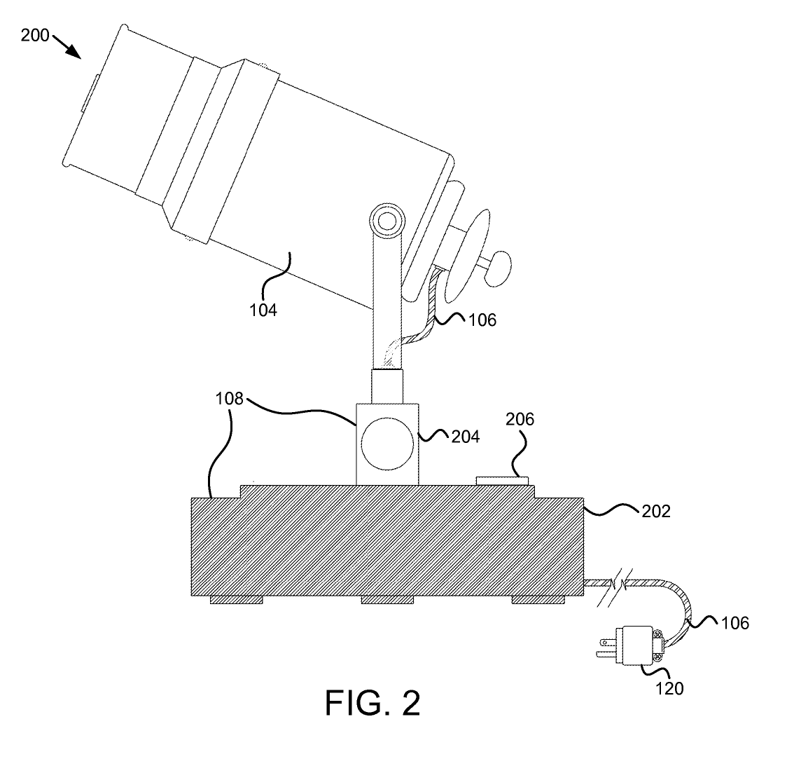

FIG. 2 is a side view illustrating another embodiment of an apparatus 200 with a portable framing projector in accordance with the present invention. The apparatus 200 includes a framing projector 102 (not shown), a projector housing 104, an electrical cord 106, a power converter 116 (not shown) and a plug 120, which are substantially similar to those described in regard the apparatus 100 of FIGS. 1A and 1B. The apparatus 200 also includes a stand 108 with a base housing 202, a support 204, and a switch 206, which are described below.

In one embodiment, the apparatus 200 includes a power converter 116 that is a part of the stand 108. The power converter 116 includes a base housing 202 surrounding the power converter 116. The base housing 202 includes a lower portion in contact with the substantially horizontal surface and is connected to a support 204 that extends from the base housing 202 to the projector housing 104 and is arranged to support the projector housing 104. The base housing 202 and the support 204 comprise the stand 108. The base housing 202 maintain the projector housing 104 and framing projector 102 in the upright position above the substantially horizontal surface.

For example, the power converter 116 may have a base housing 202 that is shaped to be in contact with the substantially horizontal surface and to maintain the support 204, projector housing 104, and framing projector 102 in the upright position. The base housing 202 may include a horizontal element that rests on the substantially horizontal surface or may extend horizontally with legs, pads, etc. that touch the substantially horizontal surface. The base housing 202 may be rectangular, circular, semispherical or other shape. In one embodiment, the power converter 116 is in the projector housing 104 and the base housing 202 is shaped, sized, and/or weighted to provide a stable base for the apparatus 200. Having the power converter 116 and other elements of the apparatus 200 in the base housing may provide a lower center of gravity for the apparatus 200 to enhance stability. In one embodiment, the base housing includes one or more weights to lower the center of gravity of the apparatus 200.

In one embodiment, the apparatus 200 includes a support that extends from the base housing 202 to the projector housing 104 and/or the framing projector 102. The support 204 may be fixed or may be adjustable to adjust a height of the framing projector 102. In one embodiment, the apparatus 200 is sized to be placed on furniture, on a stand, on a table, etc. and may be shorter than the apparatus 100 of FIGS. 1A and 1B. In one embodiment, the base housing 202 includes a switch 206. In other embodiments, the switch may be a floor switch 118 or other switch as described above in relation to the apparatus 100 of FIGS. 1A and 1B. One of skill in the art will recognize other ways to implement a switch that interrupts power to the framing projector 102 and/or the power converter 116. In one embodiment, the support 204 includes one or more adjustment mechanisms to allow movement of the projector housing 104 and/or framing projector 102 to adjust an angle of the projector housing 104 and/or framing projector 102 vertically and/or horizontally, substantially as described above in relation to the stand 108 of the apparatus 100 of FIGS. 1A and 1B.

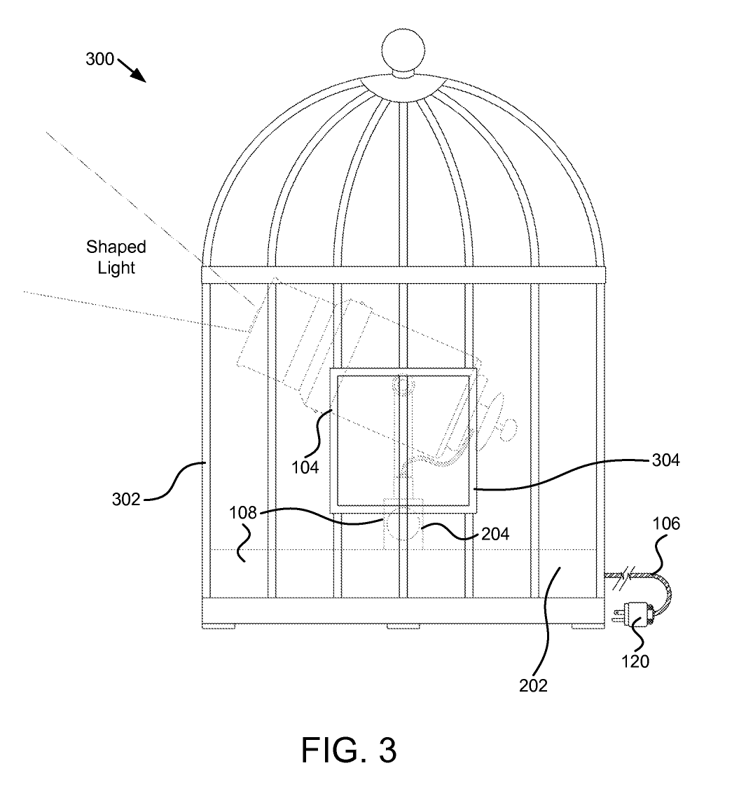

FIG. 3 is a side view illustrating another embodiment of an apparatus 300 with a portable framing projector 102 in a bird cage in accordance with the present invention. The apparatus 300, in one embodiment, includes a framing projector 102 (not shown) in a projector housing 104 with a stand 108 comprising a base housing 202 and a support 204, an electrical cord 106, and a plug 120, which may be similar to those described in relation to the apparatus 200 of FIG. 2. The apparatus 300 includes a bird cage 302 with a door 304, which are described below.

The bird cage 302, in one embodiment, includes an apparatus 200 as depicted in FIG. 2, which may be supported by a floor of the bird cage 302. In another embodiment, the bird cage 302 does not include a floor and the bird cage 302 slips over the projector housing 104 and stand 108. In another embodiment, the bird cage 302 is part of the stand 108. For example, wires of the bird cage 302 may support the projector housing 104. In one embodiment, the apparatus 300 includes a base housing 202 with a power converter 116. In another embodiment, the power converter 116 is external to the bird cage 302. In another embodiment, the apparatus 300 does not include a power converter 116.

The bird cage 302 may include decorative features such as a door 304 or a window (not shown). The decorative features may also be functional. For example, the door 304 may allow access to the projector housing 104 or other components and the window may provide an opening for shaped light from the framing projector 102.

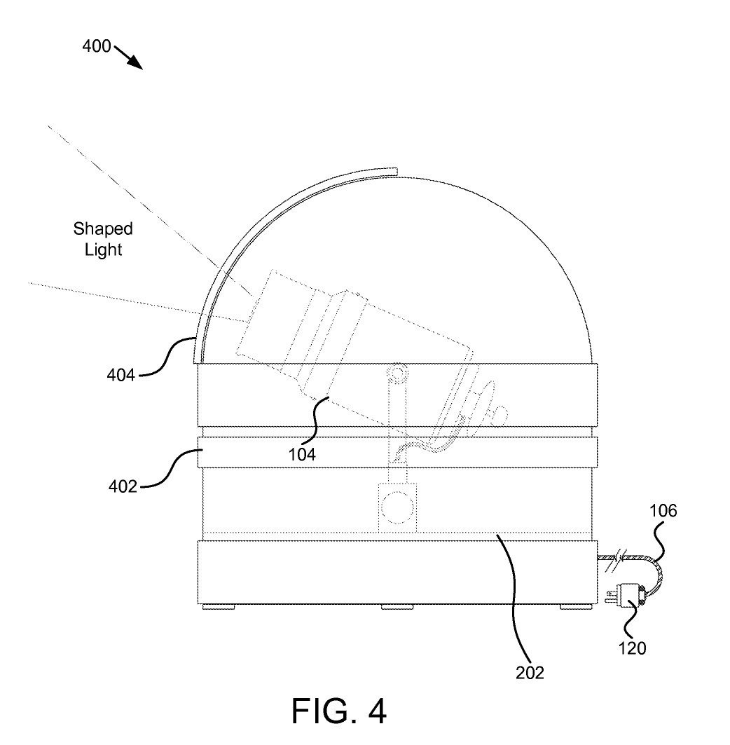

FIG. 4 is a side view illustrating another embodiment of an apparatus 400 with a portable framing projector 102 in an observatory in accordance with the present invention. The apparatus 400, in one embodiment, includes a framing projector 102 (not shown) in a projector housing 104 with a stand 108 comprising a base housing 202 and a support 204, an electrical cord 106, and a plug 120, which may be similar to those described in relation to the apparatus 200 of FIG. 2. The apparatus 400 includes an observatory 402 with an opening 404, which are described below. One of skill in the art will recognize other features of a bird cage that may be included in the bird cage 302 of the apparatus 300.

The observatory 402, in one embodiment, includes an apparatus 200 as depicted in FIG. 2, which may be supported by a floor of the observatory 402. In another embodiment, the observatory 402 does not include a floor and the observatory 402 slips over the projector housing 104 and stand 108. In another embodiment, the observatory 402 is part of the stand 108. For example, wires of the observatory 402 may support the projector housing 104. In one embodiment, the apparatus 400 includes a base housing 202 with a power converter 116. In another embodiment, the power converter 116 is external to the observatory 402. In another embodiment, the apparatus 400 does not include a power converter 116.

The observatory 402 may include decorative features such as an opening 404 or a door (not shown) or other features common to a real observatory. The decorative features may also be functional. For example, the door may allow access to the projector housing 104 or other components and the opening 404 may provide an opening for shaped light from the framing projector 102. The opening 404 may have a door to open and close, much like a real observatory. In one embodiment, the projector housing 104 is shaped like a telescope. The telescope may extend out of the observatory 402 or may be completely enclosed by the observatory 402. One of skill in the art will recognize other features of an observatory that may be included in the observatory 402 of the apparatus 400.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for lighting, the apparatus comprising:
a framing projector comprising
a light source;
one or more focusing elements that focus light from the light source on a desired area of an object, the one or more focusing elements preventing light from the light source from lighting areas outside the desired area;
a projector housing, the framing projector mounted inside the projector housing;
an electrical cord terminating at a plug, the plug configured to plug into an electrical outlet, the electrical cord for providing power to the framing projector; and
a stand coupled to one or more of the projector housing and the framing projector, the stand maintaining the projector housing and framing projector in an upright position above a substantially horizontal surface when the stand is positioned on the substantially horizontal surface, the stand supporting the projector housing and framing projector against gravity loading of the apparatus.

2. The apparatus of claim 1, wherein the stand is free from attachment to the substantially horizontal surface.

3. The apparatus of claim 1, wherein the stand comprises a tri-pod, the tri-pod comprising a base attached to the projector housing and three legs attached to the base.

4. The apparatus of claim 3, wherein the tri-pod further comprises an adjustable extension coupled to the base of the tri-pod and to the projector housing, wherein the adjustable extension adjusts to vary a height of the projector housing from the substantially horizontal surface.

5. The apparatus of claim 1, wherein the one or more focusing elements comprise a telescopic lens.

6. The apparatus of claim 1, wherein the framing projector comprises one or more of:
one or more adjustable shutters movably coupled to the framing projector, the shutters adjustable to shape light from the framing projector; and
an iris assembly connected to the framing projector, the iris assembly comprising an adjustable iris.

7. The apparatus of claim 1, wherein the framing projector further comprises a slot, the slot shaped to accommodate a custom template, the custom template shaped for the object illuminated by the framing projector.

8. The apparatus of claim 7, wherein the slot comprises a slot for an adjustable shutter and the custom template replaces the adjustable shutter.

9. The apparatus of claim 1, further comprising a power converter, the power converter mounted external to the projector housing and coupled to the stand, the power converter receiving power from the electrical cord and providing power to the framing projector, the power converter converting electrical power from the electrical cord to a different form prior to providing power to the framing projector.

10. The apparatus of claim 9, wherein the power converter comprises one or more of a ballast for the light source, an LED driver, a switching power supply and a transformer.

11. The apparatus of claim 9, wherein the power converter comprises a portion of the stand, the power converter further comprising a base housing surrounding the power converter, the base housing comprising a lower portion in contact with the substantially horizontal surface, and further comprising a support that extends from the base housing to the projector housing and arranged to support the projector housing, the base housing and the support comprising the stand, the base housing maintaining the projector housing in the upright position above the substantially horizontal surface.

12. The apparatus of claim 1, wherein the projector housing comprises an exterior in the shape of one of a spot light shape, a telescope shape, and a theatrical spotlight shape.

13. The apparatus of claim 1, wherein the stand is shaped as one or more of
a bird cage surrounding the projector housing where a window in the bird cage allows light from the framing projector to illuminate; and
an observatory shape wherein the projector housing is shaped as a telescope extending from the observatory.

14. An apparatus for lighting, the apparatus comprising:
a framing projector comprising
a light source;
one or more focusing elements that focus light from the light source on a desired area of an object, the one or more focusing elements preventing light from the light source from lighting areas outside the desired area;
one or more of
one or more adjustable shutters movably coupled to the framing projector, the shutters adjustable to shape light from the framing projector;
an iris assembly connected to the framing projector, the iris assembly comprising an adjustable iris; and
a slot shaped to accommodate a custom template, the custom template shaped for the object illuminated by the framing projector;
a projector housing, the framing projector mounted inside the projector housing;
an electrical cord terminating at a plug, the plug configured to plug into an electrical outlet, the electrical cord for providing power to the framing projector; and
a stand coupled to the projector housing, the stand maintaining the projector housing and framing projector in an upright position above a substantially horizontal surface when the stand is positioned on the substantially horizontal surface, the stand supporting the projector housing and framing projector against gravity loading of the apparatus, the stand comprising a tri-pod, the tri-pod comprising a base attached to the projector housing and three legs attached to the base.

15. The apparatus of claim 14, wherein the tri-pod further comprises an adjustable extension coupled to the base of the tri-pod and to the projector housing, wherein the adjustable extension adjusts to vary a height of the projector housing from the substantially horizontal surface.

16. The apparatus of claim 14, further comprising a power converter, the power converter mounted external to the projector housing and coupled to the stand, the power converter receiving power from the electrical cord and providing power to the framing projector, the power converter converting electrical power from the electrical cord to a different form prior to providing power to the framing projector.

17. The apparatus of claim 16, wherein the power converter comprises a portion of the stand, the power converter further comprising a base housing surrounding the power converter, the base housing comprising a lower portion in contact with the substantially horizontal surface, and further comprising a support that extends from the base housing to the projector housing and arranged to support the projector housing, the base housing and the support comprising the stand, the base housing maintaining the projector housing in the upright position above the substantially horizontal surface.

18. The apparatus of claim 16, wherein the projector housing comprises an exterior in the shape of one of a spot light shape, a telescope shape, and a theatrical spotlight shape.

19. An apparatus for lighting, the apparatus comprising:
a framing projector comprising
a light source;
one or more focusing elements that focus light from the light source on a desired area of an object, the one or more focusing elements preventing light from the light source from lighting areas outside the desired area;
one or more of
one or more adjustable shutters movably coupled to the framing projector, the shutters adjustable to shape light from the framing projector;
an iris assembly connected to the framing projector, the iris assembly comprising an adjustable iris; and
a slot shaped to accommodate a custom template, the custom template shaped for the object illuminated by the framing projector;
a projector housing, the framing projector mounted inside the projector housing, the projector housing comprising an exterior in the shape of one of a spot light shape, a telescope shape, and a theatrical spotlight shape;
an electrical cord terminating at a plug, the plug configured to plug into an electrical outlet, the electrical cord for providing power to the framing projector;
a stand coupled to the projector housing, the stand maintaining the projector housing and framing projector in an upright position above a substantially horizontal surface when the stand is positioned on the substantially horizontal surface, the stand supporting the projector housing and framing projector against gravity loading of the apparatus, the stand comprising a tri-pod, the tri-pod comprising a base attached to the projector housing and three legs attached to the base, the tri-pod comprising an adjustable extension coupled to the base of the tri-pod and to the projector housing, wherein the adjustable extension adjusts to vary a height of the projector housing from the substantially horizontal surface; and
a power converter, the power converter mounted external to the projector housing and coupled to the stand, the power converter receiving power from the electrical cord and providing power to the framing projector, the power converter converting electrical power from the electrical cord to a different form prior to providing power to the framing projector.

20. The apparatus of claim 19, wherein the power converter comprises a portion of the stand, the power converter further comprising a base housing surrounding the power converter, the base housing comprising a lower portion in contact with the substantially horizontal surface, and further comprising a support that extends from the base housing to the projector housing and arranged to support the projector housing, the base housing and the support comprising the stand, the base housing maintaining the projector housing in the upright position above the substantially horizontal surface.
